(19) United States
(12) Patent Application Publication
(10) Pub. No.: US 2014/0168999 A1
(43) Pub. Date: Jun. 19, 2014

(54) Optical Lens

(71) Applicant: TPV Display Technology (Xiamen) Co., Ltd., Xiamen (CN)

(72) Inventors: Li Mei Li, Xiamen (CN); Junyi Zheng, Xiamen (CN); Po-Iem Lin, Xiamen (CN)

(73) Assignee: TPV Display Technology (Xiamen) Co., Ltd., Xiamen (CN)

(21) Appl. No.: 14/132,036

(22) Filed: Dec. 18, 2013

(30) Foreign Application Priority Data
Dec. 19, 2012 (CN) 201210560561.8

(51) Int. Cl. F21V 5/04

(52) U.S. Cl. CPC F21V 5/045
USPC 362/338

(57) ABSTRACT

The invention relates to an optical lens utilized for disposing above a light source. The optical lens has rotational symmetry relative to the central axis thereof. The central axis of the optical lens aligns with the center of the light source. The optical lens includes a bottom surface, an emergence surface with arc shape, an incidence surface with arc and concave shape, a curved surface with annular and concave shape and a light diffusing structure. The emergence surface connects a side of the bottom surface. The incidence surface connects another side of the bottom surface and lies in the middle of the bottom surface. The curved surface lies on the bottom surface and connects the incidence surface. The light diffusing structure is disposed on the curved surface. The invention improves the distribution of light projected on a light receiving surface and prevents a bright circle formed on the light receiving surface as a result of a gap that is formed by assembly tolerance of the optical lens and the light source.

### BACKGROUND OF THE INVENTION

1. Field of the Invention

The present invention relates to an optical lens, and more particularly, to an optical lens applied to a backlight module.

2. Description of the Prior Art

Generally, the liquid crystal module utilized in the flat display device adopts the technique of thin film transistor liquid crystal display (TFT-LCD). The lighting type of TFT-LCD is inactive. The brightness the TFT-LCD need is provided by a backlight module. Then a colorful image the TFT-LCD displayed is achieved by the filtration of a color filter which filters the light provided by the backlight module.

Please refer to FIG. 1. A conventional direct type backlight module includes a light source 4 and a optical film set 6. The light source 4 adopts light emitting diode (LED). LED becomes one of the most popular light sources that utilizes in the backlight module of TFT-LCD because of smaller size and less energy consuming. Since the type of the light distribution of LED is Lambertian, the area of light spot generated on a light receiving surface above the light source 4 is relatively small. Therefore the backlight module needs to use more LEDs to perform an evenly surface light source.

Please refer to FIG. 2. There is an improvement that a secondary lens 05 is added above the light source 4 so as to change the light distribution of the light source 4, increase a diffusing angle of light rays emitted from the light source 4 and decrease the intensity of the light mixing. When the light source 4 with the secondary lens 05 is applied to the direct type backlight module, the area of the light spot generated on the optical film set 6 increases sufficiently, the amount of need of the light source 4 decreases effectively and the cost of the direct type backlight module decreases, too.

Please refer to FIG. 3. The principle of the operation of the direct type backlight module with the secondary lens describes below: When light rays pass through an incidence surface 3 and emit to an emergence surface 2, part of the light rays are reflected to a bottom surface 1, reflected again to the emergence surface 2 and then refracted toward the central axis. Which causes the intensity of light near the central axis is higher, such that the distribution of light is unevenly.

An improvement with regard to a bottom structure of the secondary lens has been presented. Please refer to FIG. 4. According to a patent of china named “Secondary lens with bottom of curved surface structure” of which application number is CN201210227219.6, the middle of a bottom surface 1 has an incidence surface 3 with arc and concave shape. The bottom surface 1 also has a curved surface with annular and concave shape connecting the incidence surface 3, so as to increase a diffusing angle of light rays emitted from a light source and decrease the intensity of light near the central axis. But the secondary lens of the patent requires very high level of machining accuracy. When the deviation of machining accuracy of the secondary lens is greater than 0.01 mm, a bright circle occurs on a light receiving surface which is above the secondary lens and the light source. Since reflected light rays are concentrated around the central axis and the curved surface on the bottom surface 1 has deviation of machining accuracy, the bright circle near the central axis occurs very easily and the distribution of light is unevenly.

Please refer to FIG. 5. The secondary lens of FIG. 5 is the same as FIG. 4 depicted. Since the influence of assembly tolerance, there is a gap formed between the light source 4 and the secondary lens. Part of the light rays will pass through the bottom surface 1 and the gap to generate the bright circle.

Please refer to FIG. 6. During assembly of the light source 4 and the secondary lens, tolerance is usually unavoidable. When the gap formed between an emitting surface of the light source 4 and the bottom surface 1 of the lens is greater than 0, the bright circle occurs because of part of light rays passing through the bottom surface 1. The bright circle is shown in FIG. 7.

Please refer to FIG. 8. Part of light rays “a” refract when passing through the incidence surface 3 then refract again when passing through the emergence surface 2, so that light rays would be diffused. Part of light rays “b” reflect when reaching the emergence surface 2. When reaching the curved surface on the bottom surface 1, the reflected light rays “b” reflect again toward outside. As a result, the intensity of light near the central axis can be decreased and the distribution of light near the central axis projected on the optical film set 6 (the light receiving surface) is evenly.

During assembly of the light source 4 and the secondary lens, tolerance and a gap are still unavoidable. As shown in FIG. 8. When the gap formed between the emitting surface of the light source 4 and the bottom surface 1 of the secondary lens is greater than 0, part of light rays “c” pass through the bottom surface 1 and, similar with the secondary lens of which bottom surface 1 is flat structure, cause the bright circle. As shown in FIG. 9.

### SUMMARY OF THE INVENTION

The present invention aims to provide an optical lens, so as to lower level of requirement of machining accuracy, increase diffusing angle of light rays and make the distribution of light more evenly.

According to the claimed invention, the optical lens, utilized for positioning above a light source, has rotational symmetry relative to a central axis thereof aligning with a center of the light source and comprises a bottom surface, an emergence surface with arc shape, an incidence surface with arc and concave shape, a curved surface with annular and concave shape and a light diffusing structure. The emergence surface connects a side of the bottom surface. The incidence surface connects another side of the bottom surface and lies in the middle of the bottom surface. The curved surface lies on the bottom surface and connects the incidence surface. The light diffusing structure is disposed on the curved surface.

According to an embodiment of the invention, the light diffusing structure includes a plurality of convex points or a plurality of concave points distributed continuously.

According to the embodiment of the invention, a radius of the convex point or a radius of the concave point is less than 0.5 mm.

According to the embodiment of the invention, an edge of the bottom surface includes at least three pillars.

According to the embodiment of the invention, a shape of a cross section of the pillar is a circle, a triangle, a tetragon, a pentagon or a hexagon.

According to the embodiment of the invention, the height of the incidence surface is greater than the width of the bottom side of the incidence surface and the height of the emergence surface is less than the width of the bottom side of the emergence surface.

According to the embodiment of the invention, when the central axis of the optical lens is y axis, a line being perpendicular to the central axis and passing through the lowest point of the bottom surface is x axis and a intersection point of the x axis and the y axis is a initial point, coordinates (x, y) of a curve of a cross section of the emergence surface starting from the central axis satisfies: x²+y² increases with an increase of |x|, coordinates (x, y) of a curve of a cross section of the incidence surface starting from the central axis satisfies: x²+y² decreases with an increase of |x| and coordinates (x, y) of a curve of a cross section of the curved surface starting from the central axis satisfies: y increases with an increase of |x|; after reaching the highest point of the curved surface, the value of y decreases with the increase of the value of |x|.

According to the embodiment of the invention, the center of the emergence surface has a concave surface, a convex surface or a flat surface.

According to the embodiment of the invention, the optical lens is further applied to a backlight module.

According to the embodiment of the invention, the light diffusing structure has a texture structure. The texture structure includes a sand ripple texture, a silks texture, a leather texture or a wave texture with staggered lines.

According to the claimed invention, another optical lens, utilized for positioning above a light source, has rotational symmetry relative to a central axis thereof aligning with a center of the light source and comprises a bottom surface, an emergence surface with arc shape, an incidence surface with arc and concave shape, a flat surface with annular shape or a curved surface with annular and concave shape and at least one round of a light diffusing structure. The emergence surface connects a side of the bottom surface. The incidence surface connects another side of the bottom surface and lies in the middle of the bottom surface. The flat surface or the curved surface lies on the bottom surface and connects the incidence surface. The light diffusing structure is/are disposed on the emergence surface. Whereby a bright circle formed on a light receiving surface above the optical lens during the operation of the light source can be improved by the light diffusing structure.

Wherein, when the central axis of the optical lens is y axis, a line being perpendicular to the central axis and passing through the lowest point of the bottom surface is x axis and a intersection point of the x axis and the y axis is a initial point, an equation of the light diffusing structure is:

x_{b}=x_{c}−(h−y_{b})tan θ₂,

wherein x_{b} is a horizontal coordinate of the light diffusing structure, x_{c} is a horizontal coordinate of the bright circle formed on the light receiving surface, h is a height from the x axis to the light receiving surface, y_{b} is a vertical coordinate of the light diffusing structure, a term (x_{b}, y_{b}) matches a curved surface equation of the emergence surface, and θ₂ is an angle of emergence of an emergence light ray passing through the emergence surface.

According to the embodiment of the invention, a radius of the convex point or a radius of the concave point is less than 0.6 mm.

The optical lens of the present invention includes the light diffusing structure disposed on the curved surface of the bottom surface, which makes the distribution of light projected on the light receiving surface more evenly and avoids the occurrence of the bright circle caused by the gap formed from assembly tolerance of the optical lens and the light source. Another optical lens of the invention includes the light diffusing structure disposed on the emergence surface, which makes the distribution of light projected on the light receiving surface more evenly and particularly avoids the occurrence of the bright circle on the light receiving surface. The optical lens of the invention further includes the pillars disposed on the edge of the bottom surface, so as to avoid shadows projected on the light receiving surface caused by the pillars.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a direct type backlight module according to prior art.

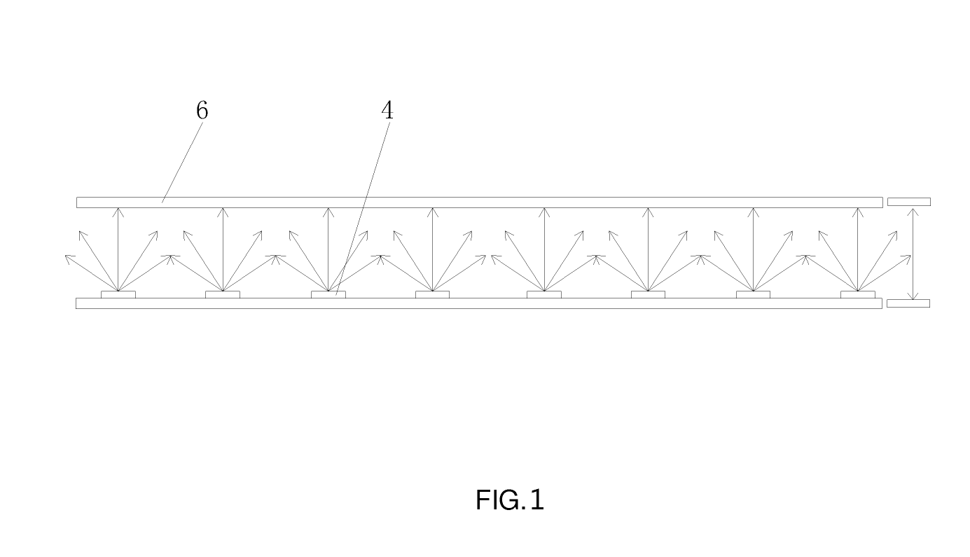

FIG. 2 is a diagram of a direct type backlight module with an optical lens according to prior art.

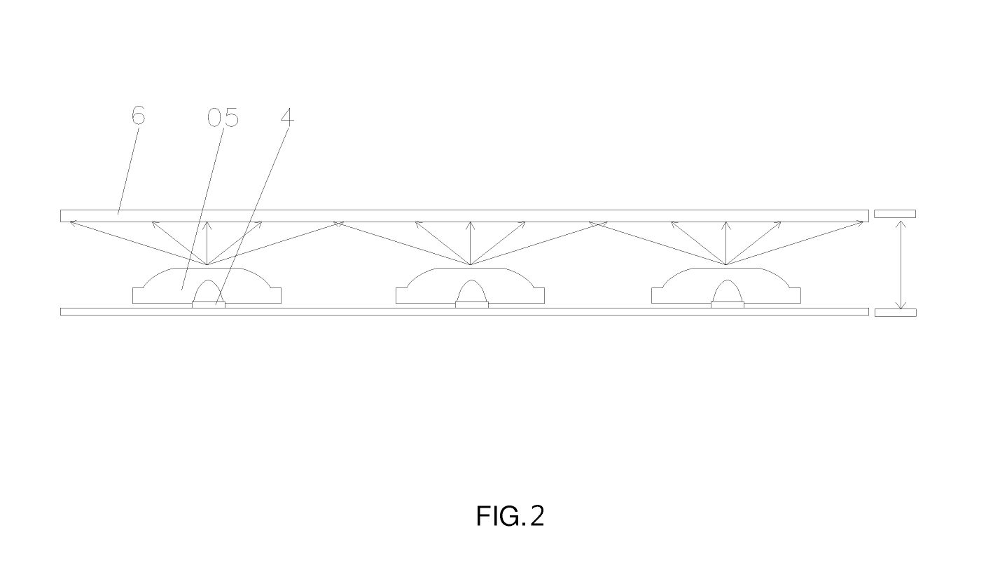

FIG. 3 is a diagram of operating principle of the direct type backlight module with the optical lens according to prior art.

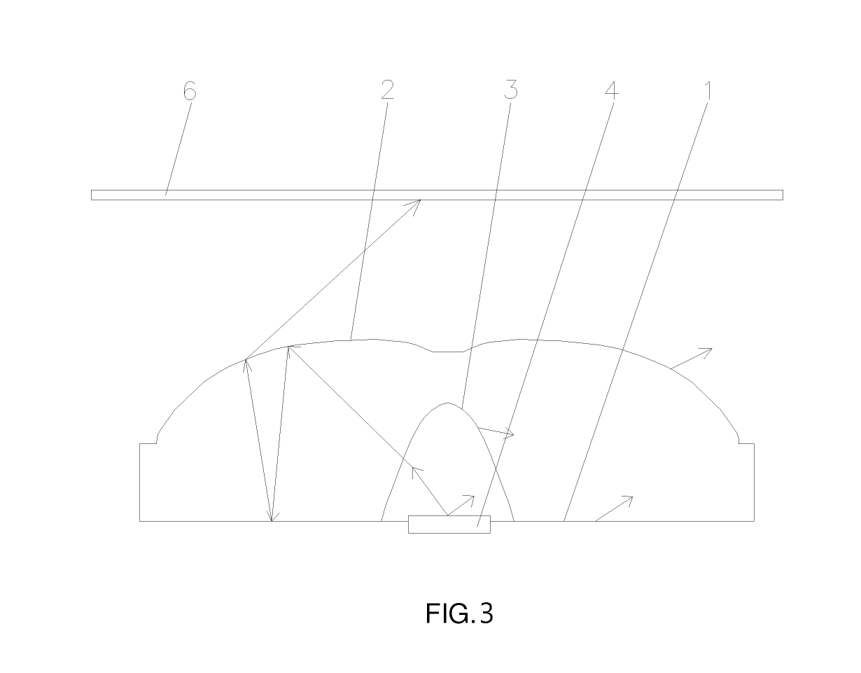

FIG. 4 is a diagram of an optical lens of which a bottom surface includes a curved surface according to prior art.

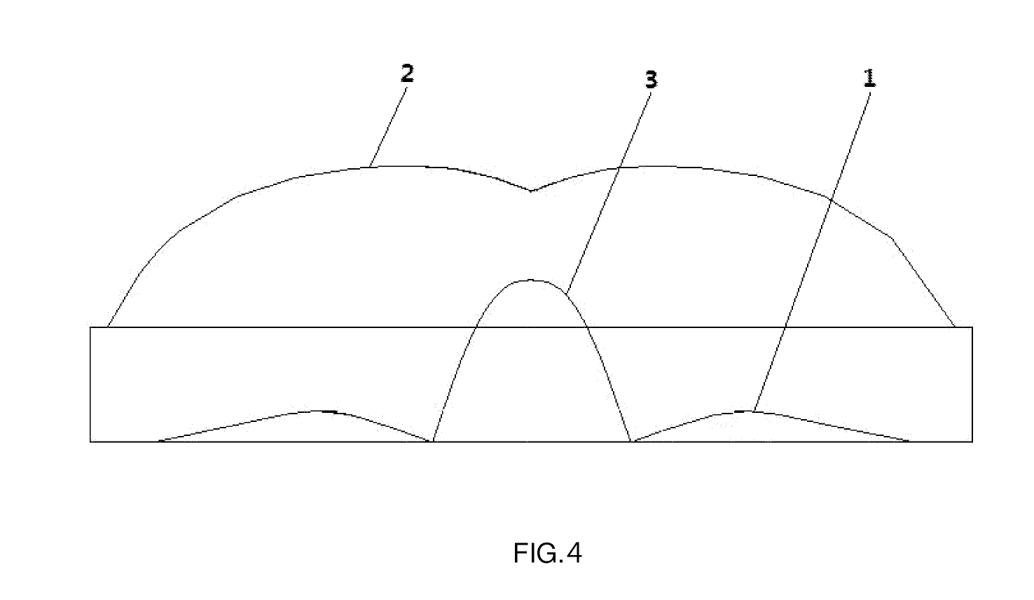

FIG. 5 is a diagram of a gap formed by assembly tolerance of the optical lens and a light source according to prior art.

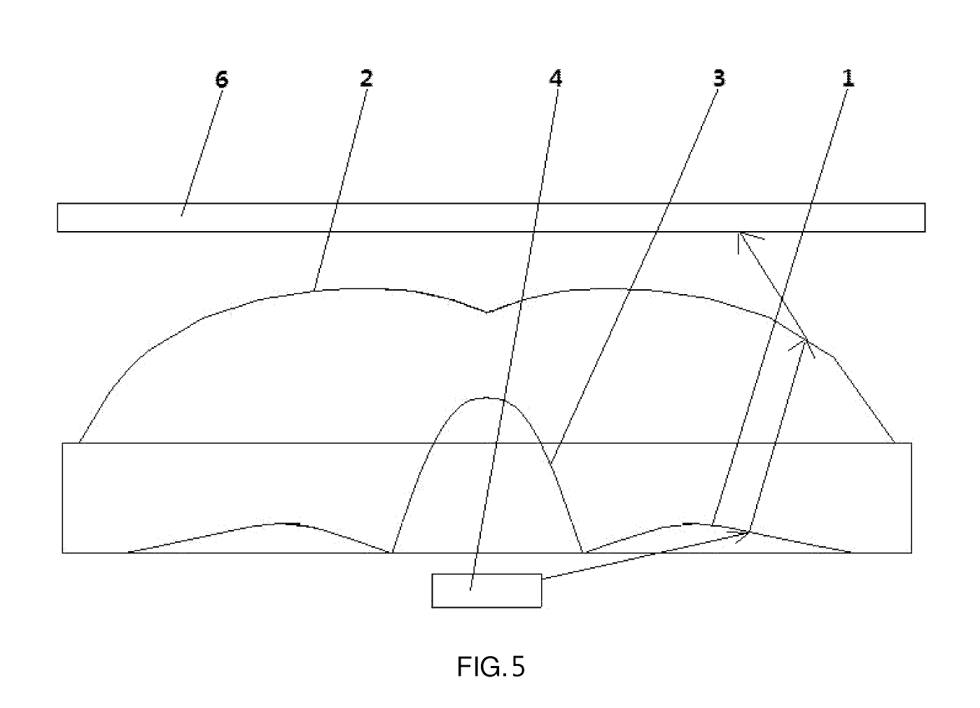

FIG. 6 is a diagram of operating principle of the optical lens having assembly tolerance according to prior art.

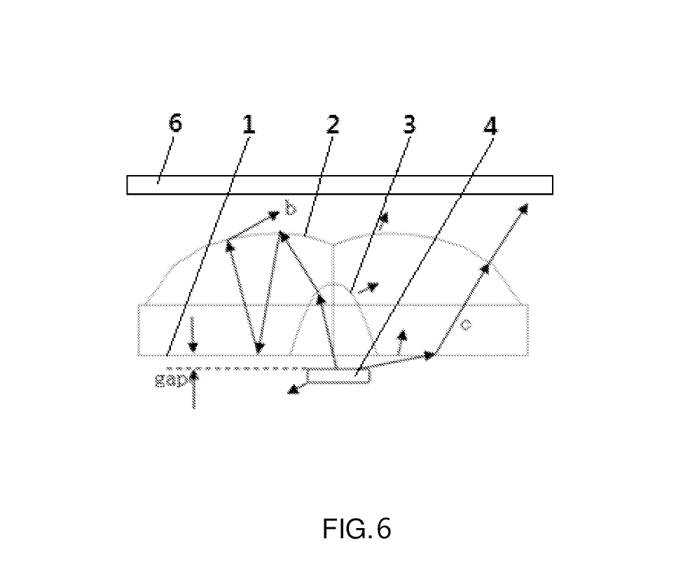

FIG. 7 is a diagram of brightness distribution of the optical lens of FIG. 6.

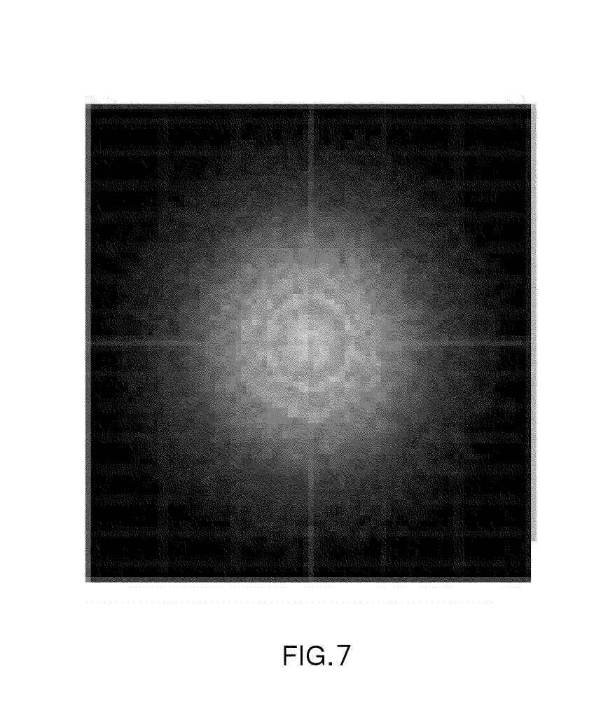

FIG. 8 is a diagram of operating principle of another optical lens having assembly tolerance according to prior art.

FIG. 9 is a diagram of brightness distribution of the optical lens of FIG. 8.

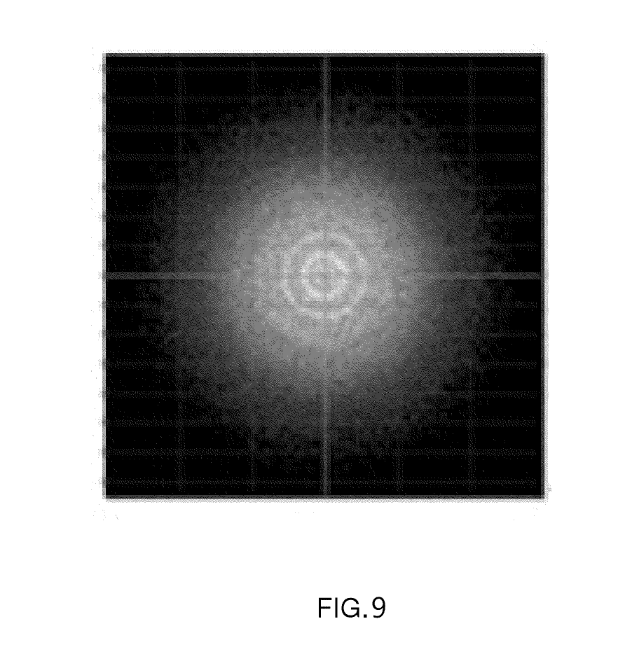

FIG. 10 is a diagram of a texture structure including a wave texture with staggered lines of a light diffusing structure.

FIG. 11 is a diagram of the texture structure including a silks texture of the light diffusing structure.

FIG. 12 is a diagram of the texture structure including a leather texture of the light diffusing structure.

FIG. 13 is a diagram of an optical lens including the light diffusing structure with the texture structure disposed on a bottom surface thereof according to a first embodiment of the present invention.

FIG. 14 is a diagram of brightness distribution of the optical lens of FIG. 13.

FIG. 15 is a diagram of an optical lens including the light diffusing structure with a plurality of concave points disposed on a bottom surface thereof according to a second embodiment of the present invention.

FIG. 16 is a diagram of brightness distribution of an optical lens without light diffusing structure according to prior art.

FIG. 17 is a diagram of brightness distribution of the optical lens of FIG. 15.

FIG. 18 is a diagram of an optical lens including the light diffusing structure with a plurality of convex points disposed on a bottom surface thereof according to a third embodiment of the present invention.

FIG. 19 is another diagram of brightness distribution of an optical lens without light diffusing structure disposed on a bottom surface thereof according to prior art.

FIG. 20 is a diagram of brightness distribution of the optical lens of FIG. 18.

FIG. 21 is a diagram of the bottom view of an optical lens with pillars disposed on an edge of a bottom surface thereof according to a fourth embodiment of the present invention.

FIG. 22 is a diagram of the optical lens with pillars disposed on the edge of the bottom surface thereof according to the present invention.

FIG. 23 is a diagram of an optical lens with light diffusing structure disposed on an emergence surface thereof according to a fifth embodiment of the present invention.

FIG. 24 is a diagram of brightness distribution of an optical lens without light diffusing structure disposed on an emergence surface thereof according to prior art.

FIG. 25 is a diagram of brightness distribution of the optical lens of FIG. 23.

FIG. 26 is a diagram of the optical lens of FIG. 23 with regard to geometry derivation of the position of the light diffusing structures.

FIG. 27 is a diagram of an optical lens with light diffusing structure disposed on an emergence surface thereof according to a sixth embodiment of the present invention.

### DETAILED DESCRIPTION

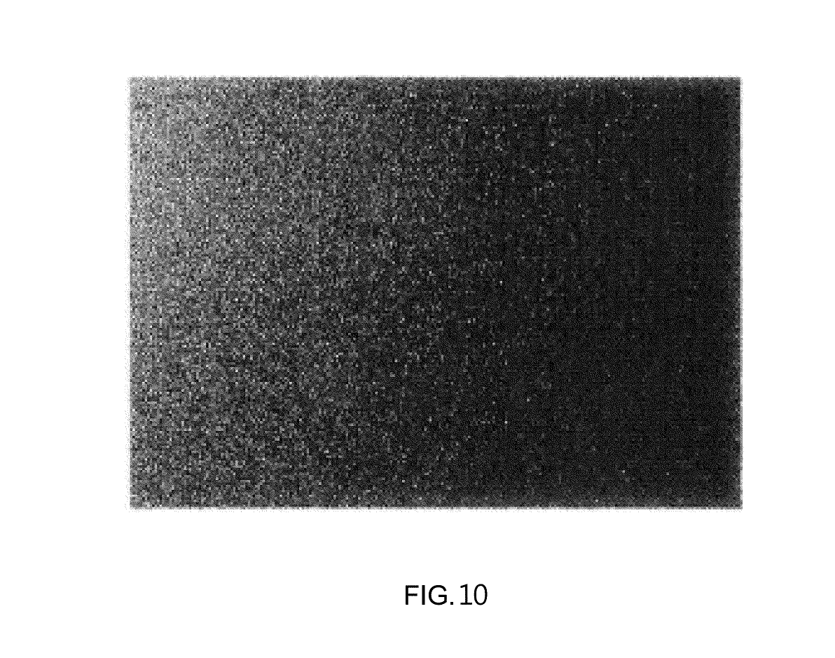

Please refer to FIG. 10 to FIG. 27. The invention provides the first optical lens, utilized for positioning above a light source 4 of a direct type backlight module. The light source 4 adopts but not limits light emitting diode (LED). The optical lens has rotational symmetry relative to a central axis thereof. The central axis of the optical lens aligns with a center of the light source 4 and comprises a bottom surface 1, an emergence surface 2 with arc shape, an incidence surface 3 with arc and concave shape, a curved surface with annular and concave shape and a light diffusing structure 5. The emergence surface 2 connects a side of the bottom surface 1. The incidence surface 3 connects another side of the bottom surface 1 and lies in the middle of the bottom surface 1. The curved surface lies on the bottom surface 1 and connects the incidence surface 3. The light diffusing structure 5 is disposed on the curved surface. Whereby a bright circle formed on a light receiving surface above the optical lens during the operation of the light source 4 can be improved by the light diffusing structure 5.

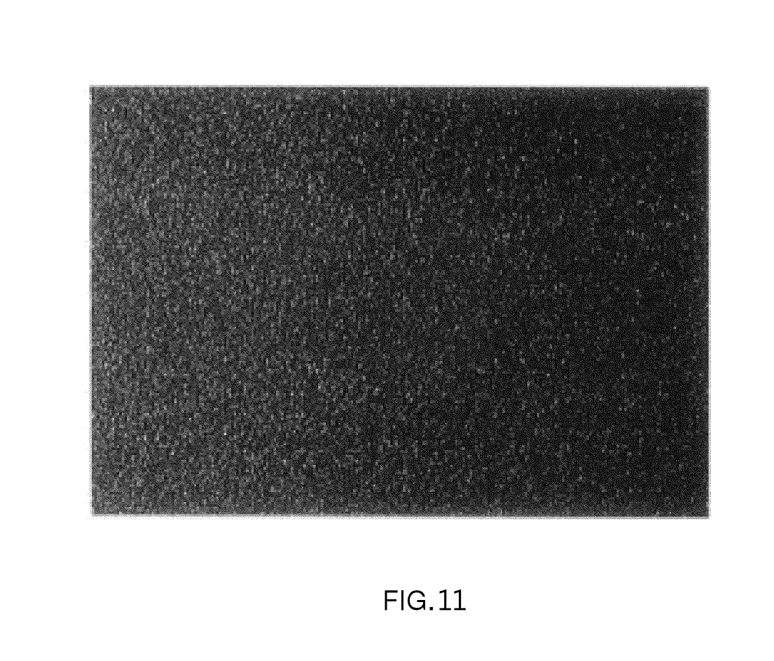

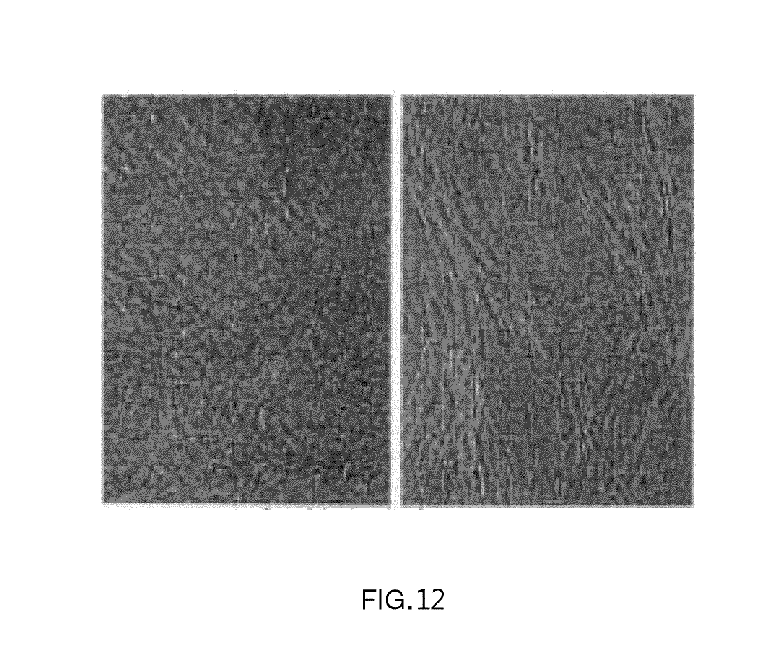

The light diffusing structure 5 of the first optical lens of the invention includes a plurality of convex points or a plurality of concave points distributed continuously. Preferably, a radius of the convex point or a radius of the concave point is less than 0.5 mm. The light diffusing structure 5 has a texture structure. The texture structure includes a sand ripple texture, a silks texture (as shown in FIG. 11), a leather texture (as shown in FIG. 12) or a wave texture with staggered lines (as shown in FIG. 10).

The invention provides the second optical lens, utilized for positioning above the light source 4. The optical lens has rotational symmetry relative to the central axis thereof. The central axis of the optical lens aligns with the center of the light source 4 and comprises a bottom surface 1, an emergence surface 2 with arc shape, an incidence surface 3 with arc and concave shape, a flat surface with annular shape or a curved surface with annular and concave shape and at least one round of a light diffusing structure 5. The emergence surface 2 connects a side of the bottom surface 1. The incidence surface 3 connects another side of the bottom surface 1 and lies in the middle of the bottom surface 1. Wherein, the bottom surface 1 can include one of or the combination of the flat surface and the curved surface. The flat surface or the curved surface lies on the bottom surface 1 and connects the incidence surface 3. The light diffusing structure 5 is/are disposed on the emergence surface 2.

Whereby the bright circle formed on a light receiving surface above the optical lens during the operation of the light source can be improved by the light diffusing structure 5.

Wherein, when the central axis of the optical lens is y axis, a line being perpendicular to the central axis and passing through the lowest point of the bottom surface 1 is x axis and a intersection point of the x axis and the y axis is a initial point, an equation of the position of the light diffusing structure 5 is:

x_{b}=x_{c}−(h−y_{b})tan θ₂,

wherein x_{b} is a horizontal coordinate of the light diffusing structure 5, x_{c} is a horizontal coordinate of the bright circle formed on the light receiving surface, h is a height from the x axis to the light receiving surface, y_{b} is a vertical coordinate of the light diffusing structure 5, a term (x_{b}, y_{b}) matches a curved surface equation of the emergence surface 2, and θ₂ is an angle of emergence of an emergence light ray passing through the emergence surface 2, which can be derived by the refractive index of the optical lens and the curved surface equation.

The light diffusing structure 5 of the second optical lens of the invention includes a plurality of convex points or a plurality of concave points. A radius of the convex point or a radius of the concave point is less than 0.6 mm. Preferably, the radius of the convex point or the radius of the concave point is less than 0.4 mm.

An edge of the bottom surface 1 of the first or the second optical lens further includes at least three pillars 7. A shape of a cross section of the pillar 7 is a circle, a triangle, a tetragon, a pentagon or a hexagon.

In regard to the first or the second optical lens, the height of the incidence surface 3 is greater than the width of the bottom side of the incidence surface 3 and the height of the emergence surface 2 is less than the width of the bottom side of the emergence surface 2. Wherein, when the central axis of the optical lens is y axis, a line being perpendicular to the central axis and passing through the lowest point of the bottom surface 1 is x axis and a intersection point of the x axis and the y axis is a initial point, coordinates (x, y) of a curve of a cross section of the emergence surface 2 starting from the central axis satisfies: x²+y² increases with an increase of |x|, coordinates (x, y) of a curve of a cross section of the incidence surface 3 starting from the central axis satisfies: x²+y² decreases with an increase of |x| and if the bottom surface 1 includes the curved surface, coordinates (x, y) of a curve of a cross section of the curved surface starting from the central axis satisfies: y increases with an increase of |x|; after reaching the highest point of the curved surface, the value of y decreases with the increase of the value of |x|.

In regard to the first or the second optical lens, the center of the emergence surface 2 has a concave surface, a convex surface or a flat surface. According to demand, a shape of the center of the emergence surface 2 matches the incidence surface 3. Since the shape of the incidence surface 3 is arc and concave, the center of the emergence surface 2 can adopt the convex surface if the intensity of the center of the light receiving surface need higher level or the center of the emergence surface 2 can adopt the concave surface or the flat surface if the intensity of the center of the light receiving surface need lower level or the distribution of light need more evenly. In addition, either the first or the second optical lens can be applied to a backlight module. The material of the optical lens can be chosen from Polyethylene terephthalate (PET), Polycarbonate (PC), Polymethylmethacrylate (PMMA), Polystyrene (PS), glass or other materials with higher transmittance.

### The First Embodiment

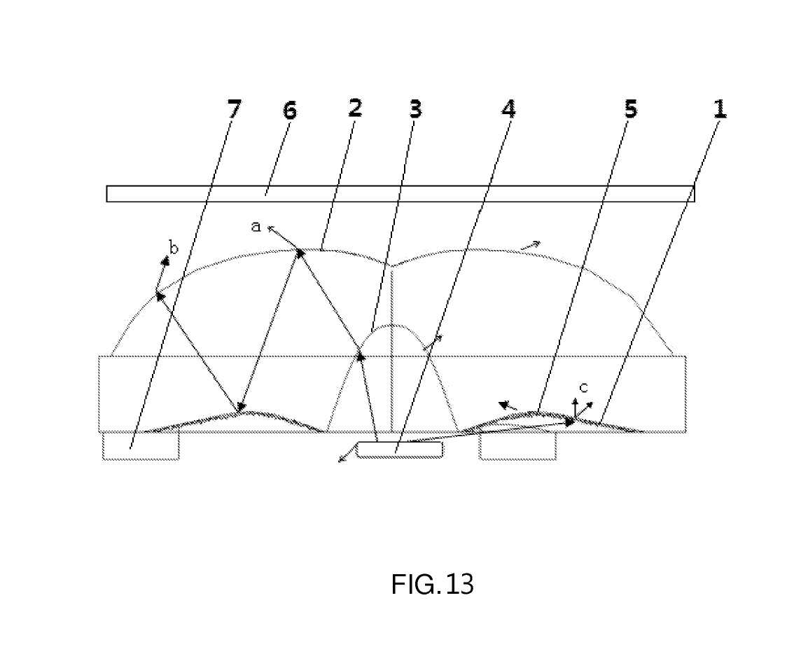

Please refer to FIG. 13. In the first embodiment, the light diffusing structure 5 is disposed on the curved surface of the bottom surface 1 of the optical lens. Part of light rays “a” refract outward when passing through the incidence surface 3 then refract outward again when passing through the emergence surface 2, so that light would be diffused. Part of light rays “b” reflect when reaching the emergence surface 2. When reaching the curved surface on the bottom surface 1, the reflected light rays “b” reflects again toward outsides and away from the center axis of the optical lens. As a result, the intensity of light near the central axis can be decreased and the distribution of light near the central axis projected on the optical film set 6 (the light receiving surface) is evenly

When a gap between an emitting surface of the light source 4 and the bottom surface 1 of the optical lens is greater than 0, Part of light rays “c” which pass through the gap and the light diffusing structure 5 on the curved surface of the bottom surface 1 are diffused. As a result, the bright circle caused by the gap of assembly tolerance can be avoided. As shown in FIG. 13, the light diffusing structure 5 on the curved surface of the bottom surface 1 has the texture structure in the embodiment. The texture structure includes the sand ripple texture, the silks texture, the leather texture or the wave texture with staggered lines.

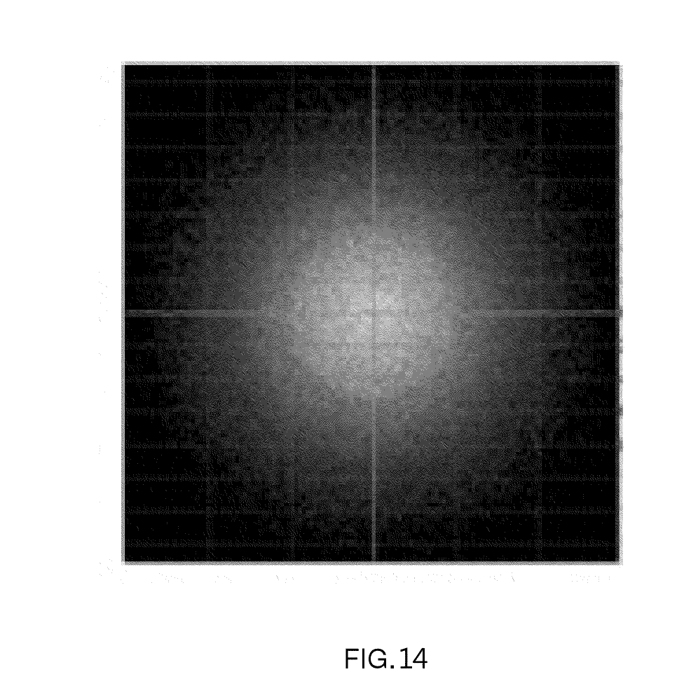

Please refer to FIG. 14 which is the diagram of brightness distribution projected on the light receiving surface in the embodiment. The distance of the gap between the light source 4 and the bottom surface 1 is 0.2 mm. As shown in FIG. 14, the distribution of light on the light receiving surface is evenly, which proves the bright circle caused by the gap can be avoided by adding the light diffusing structure 5 to the curved surface of the bottom surface 1 of the optical lens.

### The Second Embodiment

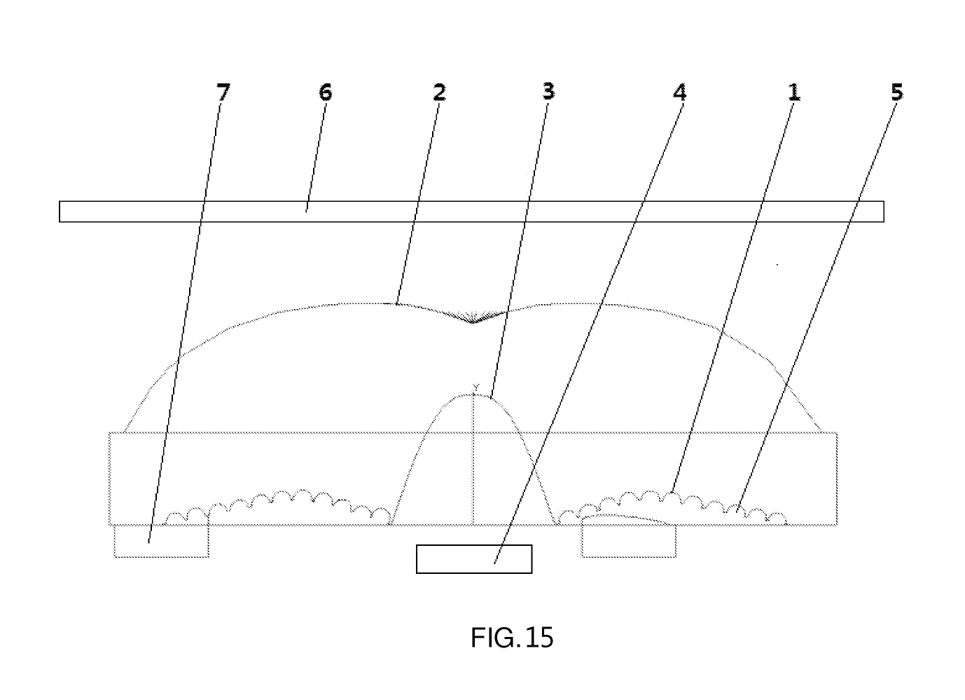

Please refer to FIG. 15. The light diffusing structure 5 includes a plurality of concave points distributed continuously. When passing through the gap and the bottom surface 1, light rays can be diffused by the light diffusing structure 5 so that the bright circle caused by the gap can be avoided.

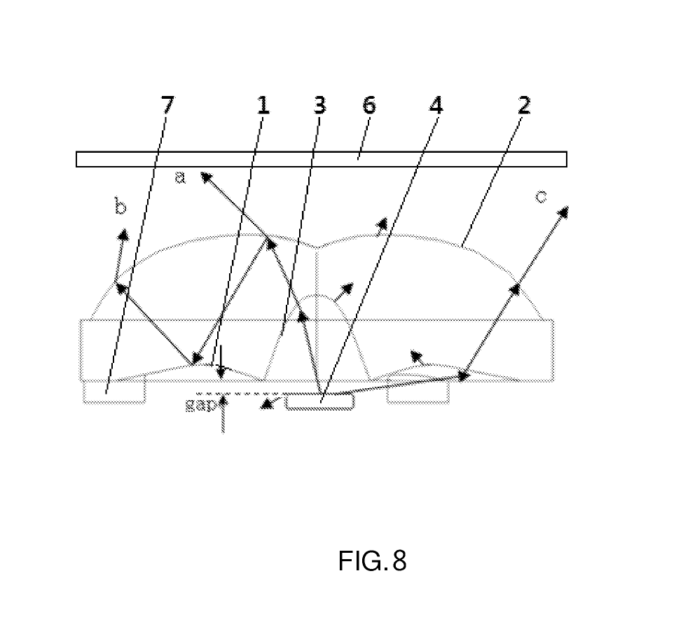

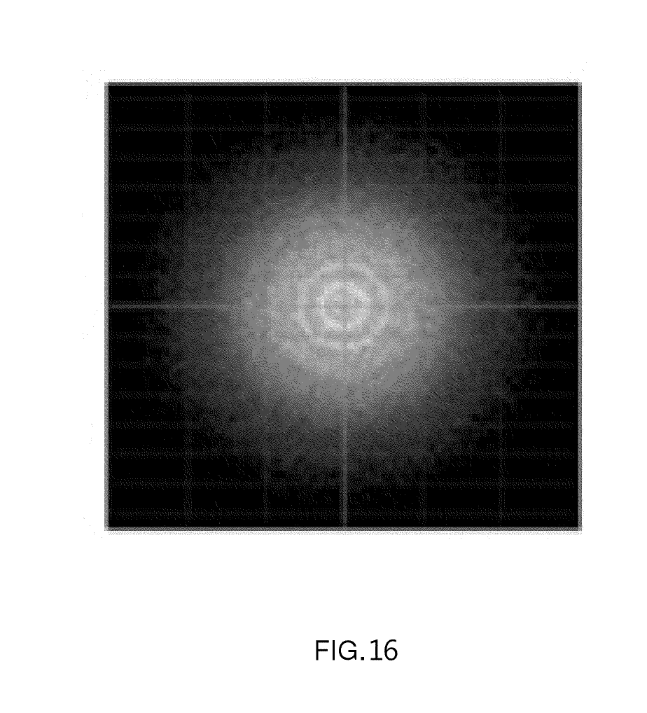

Please refer to FIG. 16. The distance of the gap between the light source 4 and the bottom surface 1 of the optical lens is 0.2 mm. The optical lens does not have any light diffusing structure (the same as the optical lens shown in FIG. 8). The bright circle is obvious in the brightness distribution.

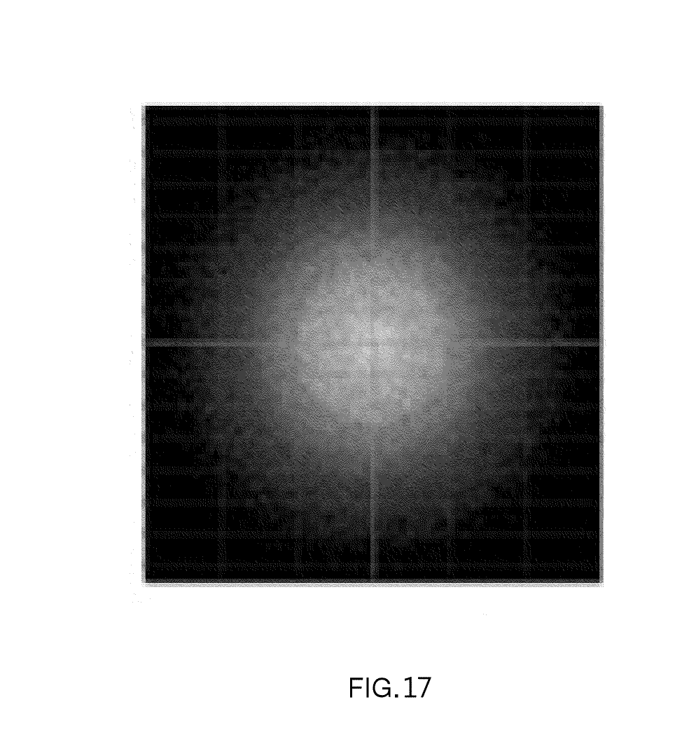

Please refer to FIG. 17. The distance of the gap between the light source 4 and the bottom surface 1 of the optical lens is 0.2 mm. FIG. 17 is a diagram of brightness distribution of the optical lens which has light diffusing structure 5 disposed on the curved surface of the bottom surface 1 and including the plurality of concave points distributed continuously. As shown in FIG. 17, the problem of the bright circle on the light receiving surface is improved effectively in the embodiment.

The applicant further simulates different sizes of concave point to utilize for the light diffusing structure. As a result of the experiments, any sizes of concave point have positive effect. And the smaller concave point has the better effect. To achieve the better effect for light diffusing, the radius of the concave point should be less than 0.5 mm.

### The Third Embodiment

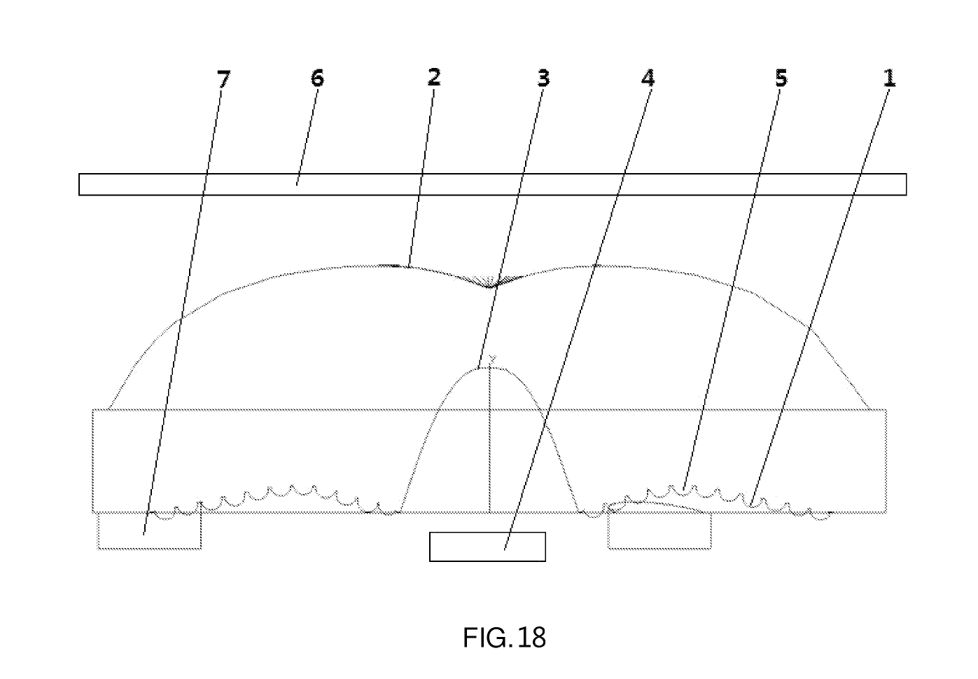

Please refer to FIG. 18. The light diffusing structure 5 includes a plurality of convex points distributed continuously. When passing through the gap and the bottom surface 1, light rays can be diffused by the light diffusing structure 5 so that the bright circle caused by the gap can be avoided.

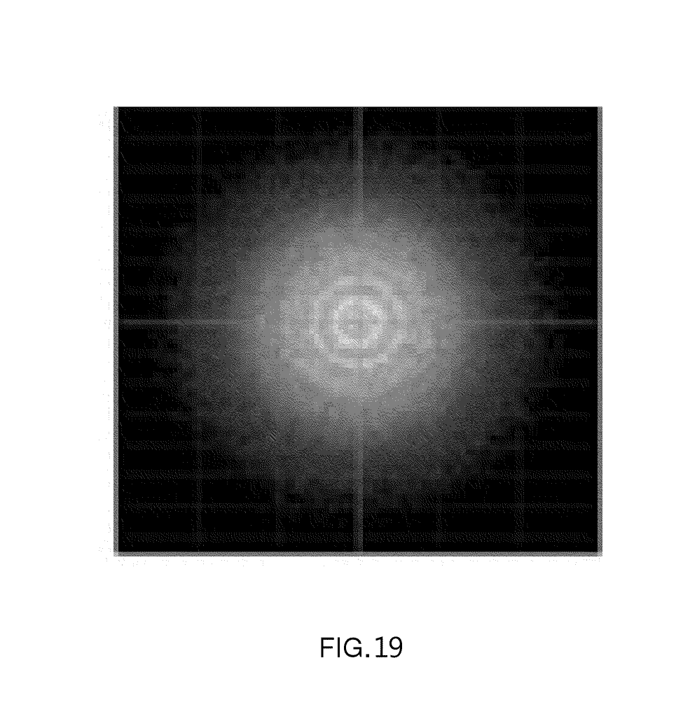

Please refer to FIG. 19. The distance of the gap between the light source 4 and the bottom surface 1 of the optical lens is 0.2 mm. The optical lens does not have any light diffusing structure. As shown in FIG. 19, the bright circle on the optical film set 6 (the light receiving surface) is obvious.

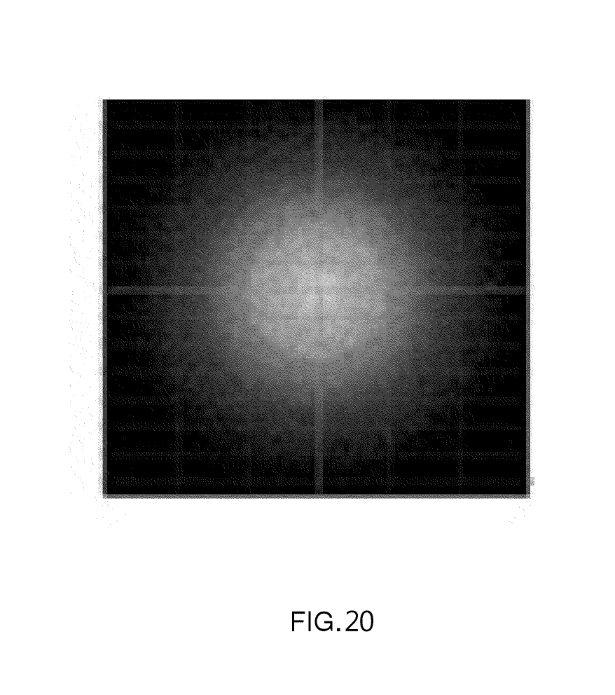

Please refer to FIG. 20. The distance of the gap between the light source 4 and the bottom surface 1 of the optical lens is 0.2 mm. The optical lens has light diffusing structure 5 disposed on the curved surface of the bottom surface 1 and including the plurality of convex points. As shown in FIG. 20, the bright circle projected on the optical film set 6 (the light receiving surface) is improved effectively in the embodiment.

The principles of the convex point are similar with the concave point. To achieve the better effect for light diffusing, the radius of the convex point should be less than 0.5 mm.

### The Fourth Embodiment

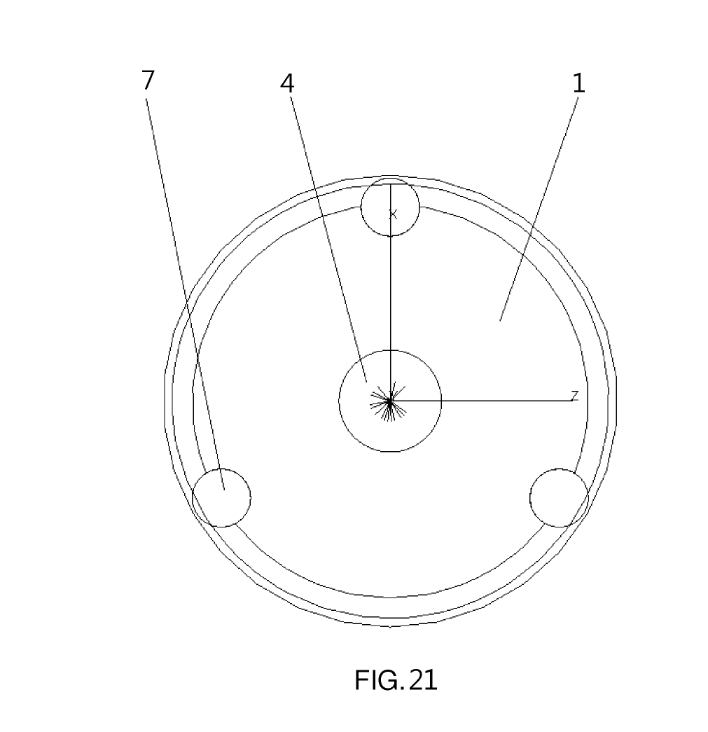

Please refer to FIG. 21. The edge of the bottom surface 1 of the optical lens further includes at least three pillars 7. The optical lens and the light source 4 are assembled with each other by the pillar 7 in an adhesive manner.

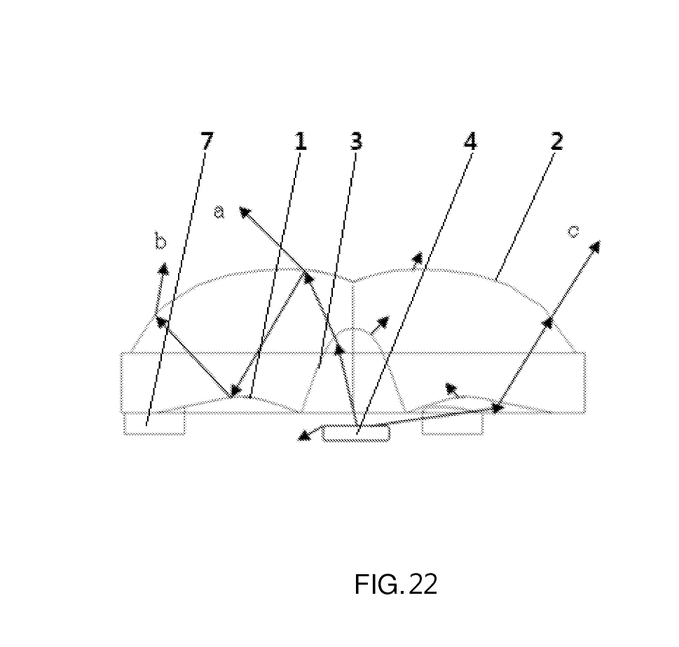

Please refer to FIG. 22. When part of light rays “a” reach the emergence surface 2, part of light rays “b” reflect to the bottom surface 1. As a result of a simulative experiment, most of the reflected light rays concentrate round the inward, i.e. on the bottom surface 1 and near the central axis, and less of them distribute outward. If the pillar 7 position near the center of the optical lens, the reflected light rays from the bottom surface 1 scatter easily to project shadows. Preferably, the pillar 7 should be positioned on the edge of the bottom surface 1.

To achieve better effect in regard to support the optical lens, the edge of the bottom surface 1 should place but not limit at least three pillars 7.

### The Fifth Embodiment

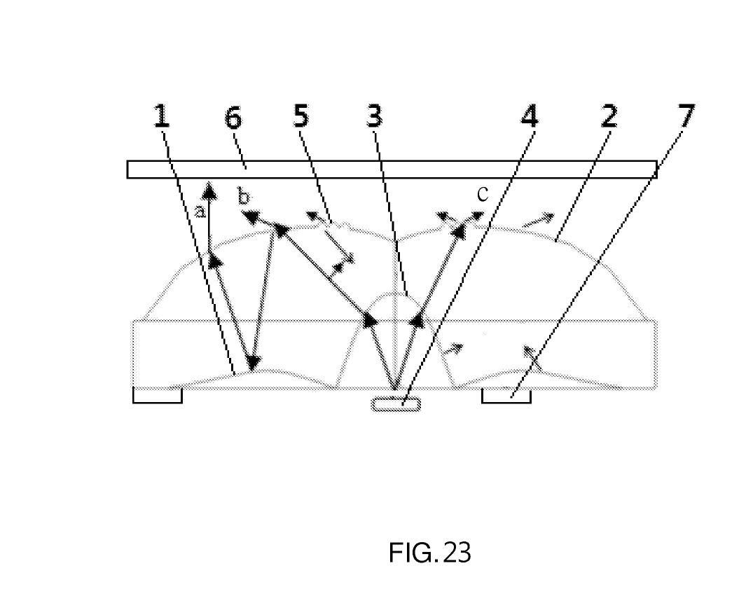

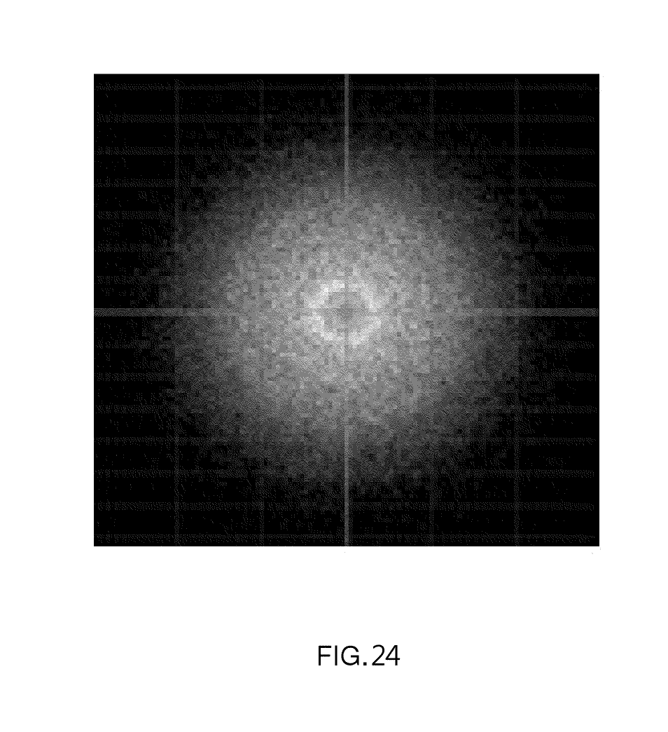

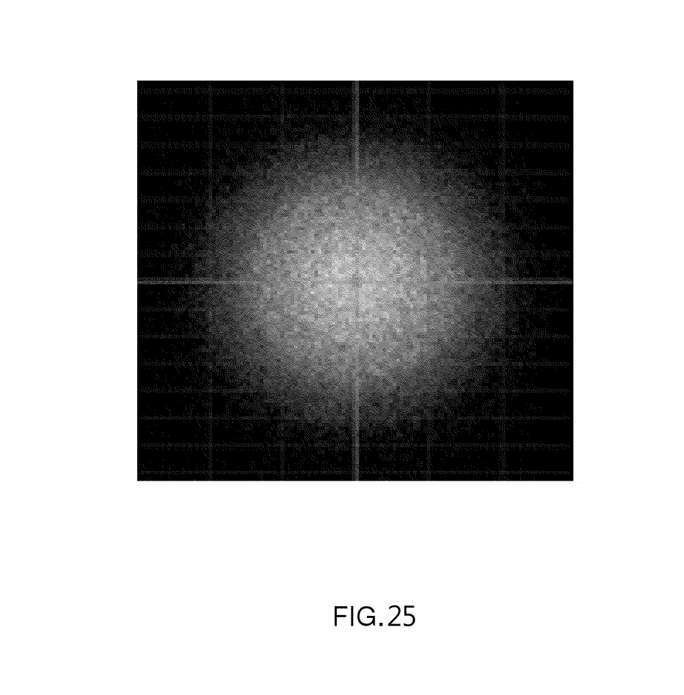

Please refer to FIG. 23. In the embodiment, the emergence surface 2 includes the light diffusing structure 5. The light diffusing structure 5 includes the convex points. When passing through the incidence surface 3, light rays are diffused away from the central axis of the optical lens. And light rays are diffused again away from the central axis when passing through the emergence surface 2. The bottom surface 1 of the optical lens includes the curved surface with annular and concave shape. Light rays passing through the curved surface of the bottom surface 1 are refracted away from the central axis to achieve better effect with regard to light diffusing. Machining accuracy of the optical lens requires high level, since the bright circle will occur if the tolerance of the curved surface is greater than 0.01 mm. If design or machining accuracy of the curved surface has tolerance, the bright circle on the optical film set 6 (the light diffusing surface) occurs easily. The bright circle can be observed from a diagram of brightness distribution on the optical film set 6 (the light diffusing surface) shown in FIG. 24. This is the reason why the light diffusing structure 5 should locate at a position corresponding to on which the bright circle occurs. The bright circle can be diffused, as shown in FIG. 25, when the corresponding position on the emergence surface 2 has been placed the light diffusing structure 5.

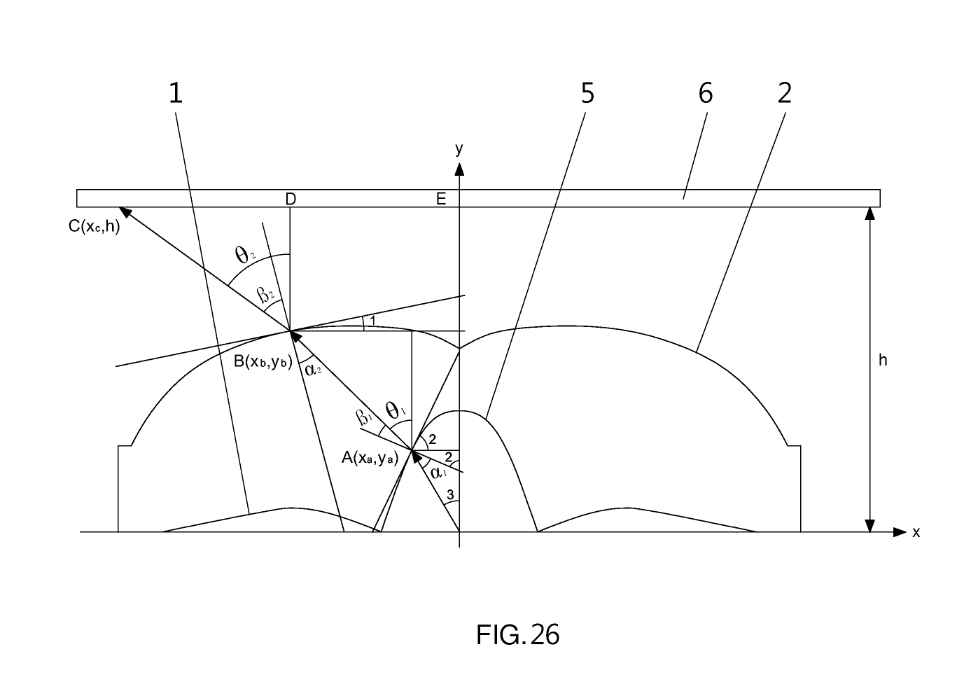

In the embodiment, the specific position of the light diffusing structure 5 can be derived by a light spot projected on the optical film set 6 (the light receiving surface). As shown in FIG. 26. The process of derivation lists blow: For an optical lens that has already been designed, the curved surface equations of the emergence surface 2 and the incidence surface 3 of the optical lens are known. Considering the central axis of the optical lens is y axis, a line being perpendicular to the central axis and passing through the lowest point of the bottom surface 1 is x axis, a intersection point of the x axis and the y axis is a initial point, a refractive index of the optical lens is nₗₑₙₛ, a height from the x axis to the optical film set 6 (the light receiving surface) is h, a slope of the A point of the incidence surface 3 is Kₐ, a slope of the B point of the emergence surface 2 is K_{b}, a coordinate of x axis of the position of the bright circle on the optical film set 6 (the light receiving surface) is x_{c}, a coordinate of x axis of the light diffusing structure 5 is x_{b}, a coordinate of y axis of the light diffusing structure 5 is y_{b}, an angle of emergence of an emergence light ray passing through and relative to the incidence surface 3 is θ₁, an angle of the emergence light ray passing through and relative to the emergence surface 2 is θ₂, an angle of refraction of the emergence light ray passing through and relative to the incidence surface 3 is β₁, an angle of refraction of the emergence light ray passing through and relative to the emergence surface 2 is β₂, an angle of incidence of an incidence light ray reaching and relative to the incidence surface 3 is α₁, an angle of incidence of the incidence light ray reaching and relative to the emergence surface 2 is α₂, an angle between a normal line of the incidence surface 3 and a horizontal line is ∠2 and an angle between the incidence light ray and y axis is ∠3.

As shown in FIG. 26, θ₁=∠2−β₁;

according to the principle of refraction: sin α₁=nₗₑₙₛ sin β₁;

α₁=∠2−∠3;

tan ∠2=Kₐ;

tan ∠3=xₐ/yₐ;

sin(∠2−∠3)=nₗₑₙₛsin β₁.

β₁ can be derived according to the slope of the incidence surface 3 and the coordinates corresponding to the incidence surface 3.

θ₁ can be derived according to the equation θ₁=∠2−β₁.

x_{b}=xₐ+(y_{b}−yₐ)tan θ₁=xₐ+(y_{b}−yₐ)tan(∠2−β₁),

wherein the coordinates of the emergence surface 2, the coordinates of the incidence surface 3, the refractive index of the optical lens, and the slope relative to the coordinates of the incidence surface 3 are relative to each other.

According to the principle of refraction: nₗₑₙₛ sin α₂=sin β₂;

tan ∠1=K_{b};

α₂+∠1=θ₁.

β₂ can be derived according to the equation nₗₑₙₛsin(θ₁−∠1)=sin β₂, wherein β₂, the refractive index of the optical lens and the slope of the emergence surface 2 are relative to each other.

θ₂ can be derived according to the equation θ₂=β₂+∠1, wherein θ₂, the refractive index of the optical lens and the slope of the emergence surface 2 are relative to each other.

x_{c}=x_{b}+(h−y_{b})tan θ₂=x_{b}+(h−y_{b})tan(β₂+∠1) (1);

according to the equation (1):

x_{b}=x_{c}−(h−y_{b})tan θ₂ (2);

In regard to the equation (2), x_{b} is a horizontal coordinate of the light diffusing structure 5, x_{c} is a horizontal coordinate of the bright circle on the optical film set 6 (the light receiving surface). Since the position of the bright circle is already known, x_{c} is known, too. h is a height for light mixing. y_{b} is a coordinate of y axis of the light diffusing structure 5. The value of tan θ₂ can be derived according the refractive index of the optical lens and the slope of the emergence surface 2.

x_{b} to which the position x_{c} of the bright circle corresponds can be derived according to the equation (2) and the practically curved surface equation of the designed emergence surface 2 (the equation relative to x_{b} and y_{b}).

### The Sixth Embodiment

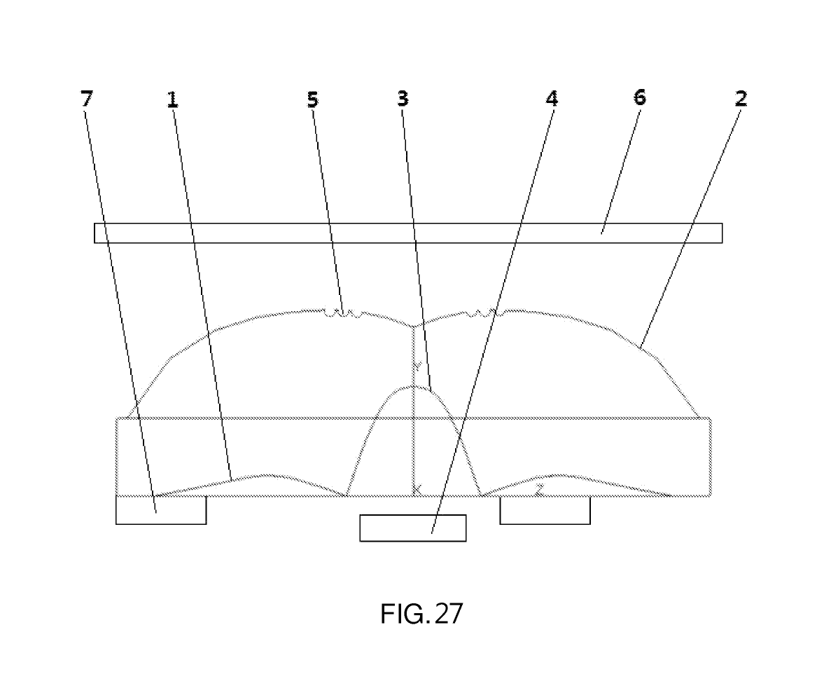

Please refer to FIG. 27. The light diffusing structure 5 includes a plurality of concave points which can avoid the bright circle as well as the convex points can do. Also the position of the concave points can be derived according to the equation (2) described in the fifth embodiment.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical lens, utilized for positioning above a light source, having rotational symmetry relative to a central axis thereof aligning with a center of the light source and comprising:
a bottom surface;
an emergence surface with arc shape connecting a side of the bottom surface;
an incidence surface with arc and concave shape connecting another side of the bottom surface and lying in the middle of the bottom surface;
a curved surface with annular and concave shape lying on the bottom surface and connecting the incidence surface; and
a light diffusing structure disposed on the curved surface.

2. The optical lens of claim 1, wherein the light diffusing structure includes a plurality of convex points or a plurality of concave points distributed continuously.

3. The optical lens of claim 2, wherein a radius of the convex point or a radius of the concave point is less than 0.5 mm.

4. The optical lens of claim 1, wherein an edge of the bottom surface includes at least three pillars.

5. The optical lens of claim 4, wherein a shape of a cross section of the pillar is a circle, a triangle, a tetragon, a pentagon or a hexagon.

6. The optical lens of claim 1, wherein the height of the incidence surface is greater than the width of the bottom side of the incidence surface and the height of the emergence surface is less than the width of the bottom side of the emergence surface;
when the central axis of the optical lens is y axis, a line being perpendicular to the central axis and passing through the lowest point of the bottom surface is x axis and a intersection point of the x axis and the y axis is a initial point,
coordinates (x, y) of a curve of a cross section of the emergence surface starting from the central axis satisfies: x²+y² increases with an increase of |x|,
coordinates (x, y) of a curve of a cross section of the incidence surface starting from the central axis satisfies: x²+y² decreases with an increase of |x|, and
coordinates (x, y) of a curve of a cross section of the curved surface starting from the central axis satisfies: y increases with an increase of |x|; after reaching the highest point of the curved surface, the value of y decreases with the increase of the value of |x|.

7. The optical lens of claim 1, wherein the center of the emergence surface has a concave surface, a convex surface or a flat surface.

8. The optical lens of claim 1 further applied to a backlight module.

9. The optical lens of claim 1, wherein the light diffusing structure has a texture structure, the texture structure includes a sand ripple texture, a silks texture, a leather texture or a wave texture with staggered lines.

10. An optical lens, utilized for positioning above a light source, having rotational symmetry relative to a central axis thereof aligning with a center of the light source and comprising:
a bottom surface;
an emergence surface with arc shape connecting a side of the bottom surface;
an incidence surface with arc and concave shape connecting another side of the bottom surface and lying in the middle of the bottom surface;
a flat surface with annular shape or a curved surface with annular and concave shape lying on the bottom surface and connecting the incidence surface; and
at least one round of a light diffusing structure disposed on the emergence surface, whereby a bright circle formed on a light receiving surface above the optical lens during the operation of the light source can be improved by the light diffusing structure,
wherein when the central axis of the optical lens is y axis, a line being perpendicular to the central axis and passing through the lowest point of the bottom surface is x axis and a intersection point of the x axis and the y axis is a initial point, an equation of the light diffusing structure is:
x_{b}=x_{c}−(h−y_{b})tan θ₂,
wherein x_{b} is a horizontal coordinate of the light diffusing structure, x_{c} is a horizontal coordinate of the bright circle formed on the light receiving surface, h is a height from the x axis to the light receiving surface, y_{b} is a vertical coordinate of the light diffusing structure, a term (x_{b}, y_{b}) matches a curved surface equation of the emergence surface, and θ₂ is an angle of emergence of an emergence light ray passing through the emergence surface.

11. The optical lens of claim 10, wherein the light diffusing structure includes a plurality of convex points or a plurality of concave points.

12. The optical lens of claim 11, wherein a radius of the convex point or a radius of the concave point is less than 0.6 mm.

13. The optical lens of claim 10, wherein an edge of the bottom surface includes at least three pillars.

14. The optical lens of claim 13, wherein a shape of a cross section of the pillar is a circle, a triangle, a tetragon, a pentagon or a hexagon.

15. The optical lens of claim 10, wherein the height of the incidence surface is greater than the width of the bottom side of the incidence surface, the height of the emergence surface is less than the width of the bottom side of the emergence surface,
coordinates (x, y) of a curve of a cross section of the emergence surface starting from the central axis satisfies: x²+y² increases with an increase of |x|,
coordinates (x, y) of a curve of a cross section of the incidence surface starting from the central axis satisfies: x²+y² decreases with an increase of |x|, and
coordinates (x, y) of a curve of a cross section of the curved surface starting from the central axis satisfies: y increases with an increase of |x|; after reaching the highest point of the curved surface, the value of y decreases with the increase of the value of |x|.

16. The optical lens of claim 10, wherein the center of the emergence surface has a concave surface, a convex surface or a flat surface.

17. The optical lens of claim 10 further applied to a backlight module.
